(19) United States
(12) Patent Application Publication
(10) Pub. No.: US 2022/0305477 A1
(43) Pub. Date: Sep. 29, 2022

(54) HONEYCOMB STRUCTURE, AND ELECTRIC HEATING SUPPORT AND EXHAUST GAS TREATMENT DEVICE EACH USING THE HONEYCOMB STRUCTURE

(71) Applicant: NGK INSULATORS, LTD., Nagoya-City (JP)

(72) Inventors: Masaki HOURA, Gifu-City (JP); Takayuki INOUE, Nagoya-City (JP); Takashi NORO, Nagoya-City (JP)

(73) Assignee: NGK INSULATORS, LTD., Nagoya-City (JP)

(21) Appl. No.: 17/644,367

(22) Filed: Dec. 15, 2021

(30) Foreign Application Priority Data
Mar. 24, 2021 (JP) 2021-050434

(51) Int. Cl. B01J 35/04; F01N 3/20; B01D 53/94

(52) U.S. Cl. CPC B01J 35/04; F01N 3/2026; B01D 53/94; B01D 2255/9155

(57) ABSTRACT

A honeycomb structure according to at least one embodiment of the present invention includes: a honeycomb structure portion having: an outer peripheral wall; and a partition wall arranged inside the outer peripheral wall to define a plurality of cells each extending from a first end surface of the honeycomb structure portion to a second end surface thereof to form a flow path; and a pair of electrode portions arranged on an outer peripheral surface of the outer peripheral wall of the honeycomb structure portion. The electrode portions are each a porous body in which particles of silicon carbide are bound by a binding material, the silicon carbide contains α-type silicon carbide and β-type silicon carbide, and the silicon carbide has a D50 in a volume-based cumulative particle size distribution of 25 μm or less.

This application claims priority under 35 U.S.C. Section 119 to Japanese Patent Application No. 2021-050434 filed on Mar. 24, 2021 which is herein incorporated by reference.

### BACKGROUND OF THE INVENTION

### 1. Field of the Invention

The present invention relates to a honeycomb structure, and an electric heating support and an exhaust gas treatment device each using the honeycomb structure.

### 2. Description of the Related Art

In recent years, there has been proposed an electric heating catalyst (EHC) in order to relieve a decrease in exhaust gas purification performance immediately after starting an engine. The EHC has a configuration in which electrodes are arranged on a honeycomb structure formed of conductive ceramics, and the honeycomb structure itself is caused to generate heat by energization, to thereby increase the temperature of a catalyst supported by the honeycomb structure to an activating temperature before starting an engine or at the time of starting the engine.

As the honeycomb structure to be used for the EHC, there is known, for example, a honeycomb structure including a honeycomb structure portion and electrode portions (paste electrodes) arranged on the honeycomb structure portion. In the technical field of EHCs, various investigations have been made on adjustment of the resistance of each of the paste electrodes with a view to uniformly energizing a honeycomb structure portion having a predetermined volume resistivity.

### SUMMARY OF THE INVENTION

A primary object of the present invention is to provide a honeycomb structure including electrode portions each capable of having its resistance adjusted in a low-resistance region. Another object of the present invention is to provide an electric heating support and an exhaust gas treatment device each using such honeycomb structure.

A honeycomb structure according to at least one embodiment of the present invention includes: a honeycomb structure portion having: an outer peripheral wall; and a partition wall arranged inside the outer peripheral wall to define a plurality of cells each extending from a first end surface of the honeycomb structure portion to a second end surface thereof to form a flow path; and a pair of electrode portions arranged on an outer peripheral surface of the outer peripheral wall of the honeycomb structure portion. The electrode portions are each a porous body in which particles of silicon carbide are bound by a binding material, the silicon carbide contains α-type silicon carbide and β-type silicon carbide, and the silicon carbide has a D50 in a volume-based cumulative particle size distribution of 25 μm or less.

In at least one embodiment, the α-type silicon carbide has a D50 of from 10 μm to 45 μm, and the β-type silicon carbide has a D50 of from 10 μm to 45 μm.

In at least one embodiment, a content of the α-type silicon carbide in the silicon carbide is from 5 mass % to 95 mass %.

In at least one embodiment, the electrode portions each have a volume resistivity of from 0.01 Ω·cm to 2.0 Ω·cm.

In at least one embodiment, the binding material contains metal silicon, a metal silicide, or a combination thereof.

According to one of other aspects, there is provided an electric heating support. The support includes: the honeycomb structure as described above; and a pair of metal terminals arranged on the pair of electrode portions of the honeycomb structure, respectively.

In at least one embodiment, the support further includes a base layer arranged between each of the electrode portions of the honeycomb structure and the metal terminal thereon.

According to one of other aspects, there is provided an exhaust gas treatment device. The device includes: the electric heating support as described above; and a can member configured to hold the electric heating support.

### BRIEF DESCRIPTION OF THE DRAWINGS

FIG. 1 is a schematic perspective view of a honeycomb structure according to at least one embodiment of the present invention.

FIG. 2 is a schematic sectional view of the honeycomb structure of FIG. 1 in a direction parallel to the flow path direction of an exhaust gas.

### DESCRIPTION OF THE EMBODIMENTS

Embodiments of the present invention are described below with reference to the drawings. However, the present invention is not limited to these embodiments.

A. Honeycomb Structure

### A-1. Entire Configuration of Honeycomb Structure

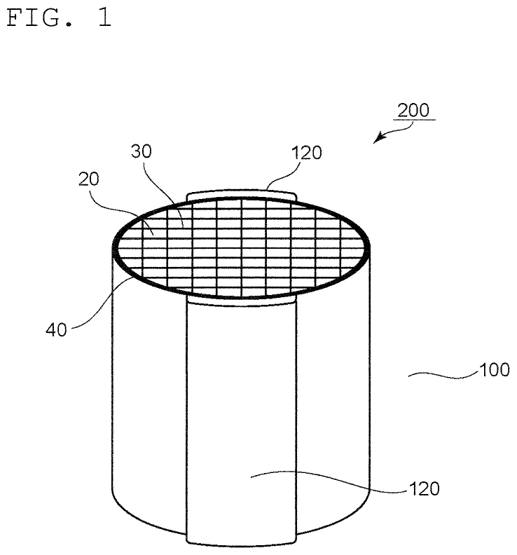

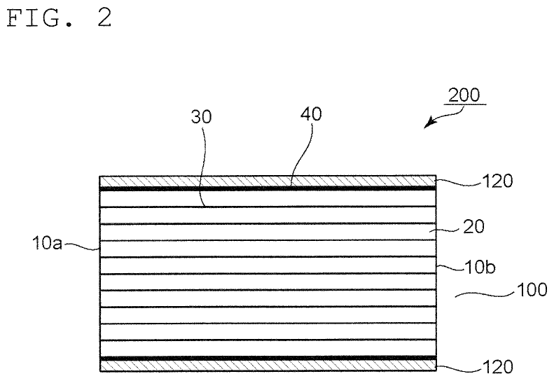

FIG. 1 is a schematic perspective view of a honeycomb structure according to at least one embodiment of the present invention, and FIG. 2 is a schematic sectional view of the honeycomb structure of FIG. 1 in a direction parallel to the flow path direction of an exhaust gas. A honeycomb structure 200 of the illustrated example includes a honeycomb structure portion 100, and a pair of electrode portions 120 and 120 arranged on side surfaces of the honeycomb structure portion 100. The honeycomb structure portion 100 has an outer peripheral wall 40, and partition walls 30 arranged inside the outer peripheral wall 40 to define a plurality of cells 20 each extending from a first end surface 10a of the honeycomb structure portion 100 to a second end surface 10b thereof to form a flow path. In FIG. 2, a fluid can flow in both left and right directions of the drawing sheet. An example of the fluid is any appropriate liquid or gas in accordance with purposes. For example, when the honeycomb structure is used for an electric heating support to be described later, the fluid is preferably an exhaust gas.

The electrode portions are arranged, for example, on the outer peripheral surface of the outer peripheral wall of the honeycomb structure portion. In the illustrated example, the electrode portions 120 and 120 are arranged on the outer peripheral surface of the outer peripheral wall 40 across the central axis of the honeycomb structure portion 100 (typically at symmetric positions with respect to the central axis). The electrode portions 120 and 120 are each typically arranged in a band shape extending along the flow path direction of the honeycomb structure portion, and for example, as in the illustrated example, are arranged over the entire flow path direction of the honeycomb structure portion (i.e., from the first end surface 10a to the second end surface 10b). With such configuration, the honeycomb structure portion can be caused to uniformly generate heat. The width of each of the electrode portions 120 and 120 is such a width that a central angle in a section in a direction orthogonal to the flow path direction of the honeycomb structure portion (angle defined by lines connecting the central axis to both ends of each of the electrode portions) may be, for example, from 15° to 65°, or for example, from 30° to 60°. With such configuration, the honeycomb structure portion can be caused to more uniformly generate heat by virtue of a synergistic effect with the effect of such setting of length in the flow path direction as described above.

In at least one embodiment of the present invention, the electrode portions 120 and 120 are each formed of a porous body in which particles of silicon carbide are bound by a binding material. Further, the silicon carbide contains α-type silicon carbide and β-type silicon carbide, and the D50 of the silicon carbide in a volume-based cumulative particle size distribution is 25 μm or less.

A-2. Honeycomb Structure Portion

The shape of the honeycomb structure portion may be appropriately designed in accordance with purposes. The honeycomb structure portion 100 of the illustrated example has a cylindrical shape (whose sectional shape in a direction orthogonal to a direction in which the cells extend is circular), but the honeycomb structure portion may have a columnar shape whose sectional shape is, for example, an oval shape or a polygon (e.g., a tetragon, a pentagon, a hexagon, a heptagon, or an octagon). The length of the honeycomb structure portion may be appropriately set in accordance with purposes. The length of the honeycomb structure portion may be, for example, from 5 mm to 250 mm, may be, for example, from 10 mm to 150 mm, or may be, for example, from 20 mm to 100 mm. The diameter of the honeycomb structure portion may be appropriately set in accordance with purposes. The diameter of the honeycomb structure portion may be, for example, from 20 mm to 200 mm, or may be, for example, from 30 mm to 100 mm. When the sectional shape of the honeycomb structure portion is not circular, the diameter of the maximum inscribed circle inscribed in the sectional shape (e.g., polygon) of the honeycomb structure portion may be adopted as the diameter of the honeycomb structure portion.

The partition walls 30 and the outer peripheral wall 40 are each typically formed of ceramics containing silicon carbide and silicon (hereinafter sometimes referred to as “silicon carbide-silicon composite material”). The ceramics contains silicon carbide and silicon at a total of, for example, 90 mass % or more, or for example, 95 mass % or more. With such configuration, the volume resistivity of the honeycomb structure portion at 25° C. can be allowed to fall within predetermined ranges. The volume resistivity of the honeycomb structure portion is preferably from 0.1 Ω·cm to 200 Ω·cm, more preferably from 1.0 Ω·cm to 200 Ω·cm. According to at least one embodiment of the present invention, the electrode portions are each made to have such a predetermined configuration as described later, and thus the honeycomb structure portion having such volume resistivity can be uniformly energized. The ceramics may contain a substance other than the silicon carbide-silicon composite material. An example of such substance is strontium.

The silicon carbide-silicon composite material typically contains silicon carbide particles serving as aggregates, and silicon serving as a binding material for binding the silicon carbide particles. In the silicon carbide-silicon composite material, for example, a plurality of silicon carbide particles are bound by silicon so as to form pores between the silicon carbide particles. That is, the partition walls 30 and the outer peripheral wall 40 each containing the silicon carbide-silicon composite material may each be, for example, a porous body.

The content ratio of silicon in the silicon carbide-silicon composite material is preferably from 10 mass % to 40 mass %, more preferably from 15 mass % to 35 mass %. When the content ratio of silicon is excessively low, the strength of the honeycomb structure portion (consequently of the honeycomb structure) becomes insufficient in some cases. When the content ratio of silicon is excessively high, the shape of the honeycomb structure portion cannot be retained at the time of its firing in some cases.

The average particle diameter of the silicon carbide particles is preferably from 3 μm to 50 μm, more preferably from 3 μm to 40 μm, still more preferably from 10 μm to 35 μm. When the average particle diameter of the silicon carbide particles falls within such ranges, the volume resistivity of the honeycomb structure portion can be allowed to fall within such appropriate ranges as described above. When the average particle diameter of the silicon carbide particles is excessively large, a forming die is clogged with a raw material in the forming of a honeycomb formed body serving as a precursor of the honeycomb structure portion in some cases. The average particle diameter of the silicon carbide particles may be measured by, for example, a laser diffraction method.

The average pore diameter of each of the partition walls 30 and the outer peripheral wall 40 is preferably from 2 μm to 20 μm, more preferably from 2 μm to 15 μm, still more preferably from 4 μm to 8 μm. When the average pore diameter of the partition walls falls within such ranges, the volume resistivity can be allowed to fall within the above-mentioned appropriate ranges. The average pore diameter may be measured with, for example, a mercury porosimeter.

The porosity of each of the partition walls 30 and the outer peripheral wall 40 is preferably from 15% to 60%, more preferably from 30% to 45%. When the porosity is excessively low, the deformation of the honeycomb structure portion at the time of its firing is increased in some cases. When the porosity is excessively high, the strength of the honeycomb structure portion becomes insufficient in some cases. The porosity may be measured with, for example, a mercury porosimeter.

The thickness of each of the partition walls 30 may be appropriately set in accordance with purposes. The thickness of each of the partition walls 30 may be, for example, from 50 μm to 0.3 mm, or may be, for example, from 150 μm to 250 μm. When the thickness of each of the partition walls falls within such ranges, the mechanical strength of the honeycomb structure portion (consequently of the honeycomb structure) can be made sufficient, and besides, an opening area (total area of cells in a section) can be made sufficient, with the result that pressure loss at the time of flowing an exhaust gas in the case of using the honeycomb structure as a catalyst support can be suppressed.

The density of each of the partition walls 30 may be appropriately set in accordance with purposes. The density of each of the partition walls 30 may be, for example, from 0.5 g/cm³ to 5.0 g/cm³. When the density of each of the partition walls falls within such range, the honeycomb structure portion (consequently the honeycomb structure) can be lightweighted, and besides, the mechanical strength thereof can be made sufficient. The density may be measured by, for example, an Archimedes method.

In at least one embodiment of the present invention, the thickness of the outer peripheral wall 40 is larger than the thickness of each of the partition walls 30. With such configuration, the outer peripheral wall can be suppressed from undergoing a breakage, a fracture, a crack, or the like due to an external force (e.g., an impact from the outside, or a thermal stress due to a temperature difference between an exhaust gas and the outside). The thickness of the outer peripheral wall 40 is, for example, 0.05 mm or more, preferably 0.1 mm or more, more preferably 0.15 mm or more. However, when the outer peripheral wall is made excessively thick, its heat capacity is increased to enlarge a temperature difference between the inner peripheral side of the outer peripheral wall and a partition wall on the inner peripheral side, resulting in a reduction in thermal shock resistance in some cases. In view of this, the thickness of the outer peripheral wall is preferably 1.0 mm or less, more preferably 0.7 mm or less, still more preferably 0.5 mm or less.

The cells 20 each have any appropriate sectional shape in the direction orthogonal to the direction in which the cell extends. In the illustrated example, the partition walls 30 defining the cells are orthogonal to each other to define the cells 20 each having a sectional shape that is a tetragon (square in the illustrated example) except in parts in contact with the outer peripheral wall 40. The sectional shape of each of the cells 20 may be a shape other than the square, such as a triangle, a pentagon, a hexagon, or a higher polygon. The sectional shape of each of the cells is preferably a tetragon or a hexagon. With such configuration, there is an advantage in that the pressure loss at the time of flowing an exhaust gas is small, resulting in excellent purification performance.

A cell density in the direction orthogonal to the direction in which the cells 20 extend (i.e., the number of the cells 20 per unit area) may be appropriately set in accordance with purposes. The cell density is preferably from 40 cells/cm² to 150 cells/cm², more preferably from 50 cells/cm² to 150 cells/cm², still more preferably from 70 cells/cm² to 100 cells/cm². When the cell density falls within such ranges, the strength and effective geometric surface area (GSA, i.e., catalyst supporting area) of the honeycomb structure portion can be sufficiently secured, and besides, the pressure loss at the time of flowing an exhaust gas can be suppressed.

A-3. Electrode Portions

As described above, the electrode portions are each formed of a porous body in which particles of silicon carbide are bound by a binding material. Typical examples of the binding material include metal silicon and a metal silicide. Those binding materials may be used alone or in combination thereof. As a metal serving as a component of the metal silicide, there are given, for example, nickel, zirconium, and a combination thereof. In each of the electrode portions, for example, a plurality of silicon carbide particles are bound by the binding material so as to form pores between the silicon carbide particles. The content of the silicon carbide in each of the electrode portions is preferably from 50 mass % to 90 mass %, more preferably from 60 mass % to 80 mass %, still more preferably from 65 mass % to 75 mass %. The content of the binding material in each of the electrode portions is preferably from 10 mass % to 50 mass %, more preferably from 20 mass % to 40 mass %. When the contents of the silicon carbide and the binding material fall within such ranges, a sufficient SiC-binding strength can be obtained. When the binding material (typically the metal silicon) is in excess, there is a risk in that the binding material (typically the metal silicon) cannot be maintained in the structure for a production reason.

In at least one embodiment of the present invention, the silicon carbide contains α-type silicon carbide (hereinafter sometimes referred to as “α-SiC”) and β-type silicon carbide (hereinafter sometimes referred to as “β-SiC”). Through combined use of α-SiC and β-SiC for each of the electrode portions, electrode portions each capable of having its resistance adjusted in a low-resistance region can be formed. When α-SiC is used alone, low-resistance electrode portions cannot be achieved in some cases. When β-SiC is used alone, there is a risk in that the resistance may become so low that an excessive current locally flows in each of the electrode portions. The content of α-SiC in the silicon carbide is preferably from 5 mass % to 95 mass %. The content of α-SiC may be, for example, from 5 mass % to 30 mass %, may be, for example, from 5 mass % to 15 mass %, may be, for example, from 10 mass % to 50 mass %, may be, for example, from 10 mass % to 30 mass %, may be, for example, from 20 mass % to 80 mass %, may be, for example, from 30 mass % to 70 mass %, may be, for example, from 30 mass % to 50 mass %, may be, for example, from 50 mass % to 70 mass %, may be, for example, from 70 mass % to 95 mass %, or may be, for example, from 85 mass % to 95 mass %. When the content of α-SiC in the silicon carbide falls within such ranges, the above-mentioned effect becomes more remarkable. Herein, the expression “SiC” is intended to encompass not only pure SiC, but also SiC containing inevitable impurities.

In at least one embodiment of the present invention, the D50 of the silicon carbide in a volume-based cumulative particle size distribution is 25 μm or less as described above, and is preferably from 5 μm to 25 μm, more preferably from 10 μm to 25 μm, still more preferably from 10 μm to 20 μm. When the D50 of the silicon carbide falls within such ranges, in the case where a base layer (e.g., a thermally sprayed base layer) is formed between each of the electrode portions and a metal terminal in the electric heating support to be described later, satisfactory continuity with the base layer can be secured. The D50 of the silicon carbide may be, for example, 20 μm or less, may be, for example, 18 μm or less, or may be, for example, 15 μm or less.

The D10 of the silicon carbide in the volume-based cumulative particle size distribution is preferably from 3 μm to 20 μm, more preferably from 5 μm to 15 μm. The D90 of the silicon carbide in the volume-based cumulative particle size distribution is preferably from 15 μm to 65 μm, more preferably from 15 μm to 55 μm.

The D50 of α-SiC is preferably from 10 μm to 45 μm. The D50 of α-SiC may be, for example, from 10 μm to 18 μm, may be, for example, from 10 μm to 15 μm, may be, for example, from 25 μm to 45 μm, or may be, for example, from 30 μm to 45 μm. When the D50 of α-SiC falls within such ranges, there can be formed electrode portions each of which is capable of having its resistance adjusted in a more appropriate low-resistance region, and besides, is capable of more stably maintaining the adjusted resistance value. Further, when a base layer (e.g., a thermally sprayed base layer) is formed between each of the electrode portions and a metal terminal in the electric heating support to be described later, satisfactory continuity with the base layer can be secured. The D50 of β-SiC is preferably from 10 μm to 45 μm, more preferably from 18 μm to 25 μm.

The D10 of α-SiC is preferably from 3 μm to 30 μm, more preferably from 5 μm to 20 μm. In addition, the D90 of α-SiC is preferably from 10 μm to 90 μm, more preferably from 15 μm to 80 μm, still more preferably from 15 μm to 60 μm. The D10 of β-SiC is preferably from 3 μm to 30 μm, more preferably from 5 μm to 20 μm. The D90 of α-SiC is preferably from 10 μm to 90 μm, more preferably from 15 μm to 65 μm, still more preferably from 20 μm to 65 μm. The D10, D50, and D90 of α-SiC, and the D10, D50, and D90 of β-SiC may be measured by, for example, a laser diffraction method.

The volume resistivity of each of the electrode portions is preferably from 0.01 Ω·cm to 2.0 Ω·cm, more preferably from 0.05 Ω·cm to 1.8 Ω·cm, still more preferably from 0.07 Ω·cm to 1.6 Ω·cm, particularly preferably from 0.07 Ω·cm to 1.2 Ω·cm. Through combined use of α-SiC and β-SiC for each of the electrode portions, the resistance can be adjusted in such low-resistance region, and besides, the adjusted resistance value can be stably maintained. In particular, according to at least one embodiment of the present invention, even when the volume resistivity of the honeycomb structure portion fluctuates, a satisfactory heat generation distribution can be achieved at the time of energization heating by controlling the volume resistivity of each of the electrode portions to the range of from 0.07 Ω·cm to 1.2 Ω·cm. The volume resistivity of each of the electrode portions is a value measured at 25° C. by a four-terminal method.

The porosity of each of the electrode portions is preferably from 15% to 60%, more preferably from 18% to 50%, still more preferably from 19% to 40%. The porosity may be determined, for example, using image processing software from an image obtained by observing a section of each of the electrode portions with a scanning electron microscope (SEM).

The thickness of each of the electrode portions is preferably from 50 μm to 300 μm, more preferably from 100 μm to 200 μm, still more preferably from 100 μm to 150 μm. When the thickness of each of the electrode portions falls within such ranges, the honeycomb structure portion can be caused to uniformly generate heat, and besides, electrode portions each having satisfactory thermal shock resistance can be formed. When the thickness of each of the electrode portions is excessively small, it becomes difficult to cause the honeycomb structure portion to uniformly generate heat in some cases. When the thickness of each of the electrode portions is excessively large, the thermal shock resistance of each of the electrode portions becomes insufficient in some cases.

A-4. Production Method for Honeycomb Structure

The honeycomb structure may be produced by any appropriate method. A typical example thereof is described below.

First, metal silicon powder, a binder, a surfactant, a pore former, water, and the like are added to silicon carbide powder to prepare a honeycomb structure portion-forming raw material (hereinafter sometimes referred to simply as “forming raw material”). As described in the section A-2, the metal silicon powder may be blended at preferably from 10 mass % to 40 mass % with respect to the sum of the mass of the silicon carbide powder and the mass of the metal silicon powder. As described in the section A-2, the average particle diameter of silicon carbide particles in the silicon carbide powder is preferably from 3 μm to 50 μm. The average particle diameter of metal silicon particles in the metal silicon powder is preferably from 2 μm to 35 μm. When the average particle diameter of the metal silicon particles is excessively small, the volume resistivity of the honeycomb structure portion to be obtained becomes excessively low in some cases. When the average particle diameter of the metal silicon particles is excessively large, the volume resistivity of the honeycomb structure portion to be obtained becomes excessively high in some cases. The total content of the silicon carbide powder and the metal silicon powder may be appropriately set in accordance with the configuration desired of the honeycomb structure portion to be obtained. The total content is preferably from 30 mass % to 78 mass % with respect to the mass of the entirety of the forming raw material. The average particle diameter of the metal silicon particles may be measured by, for example, a laser diffraction method.

Examples of the binder include methyl cellulose, hydroxypropoxyl cellulose, hydroxyethyl cellulose, carboxymethyl cellulose, and polyvinyl alcohol. Of those, methyl cellulose and hydroxypropoxyl cellulose are preferably used in combination. The content of the binder may also be appropriately set in accordance with the configuration desired of the honeycomb structure portion to be obtained. The content of the binder is preferably from 2 mass % to 10 mass % with respect to 100 parts by mass of the total mass of the silicon carbide powder and the metal silicon powder.

Examples of the surfactant include ethylene glycol, a dextrin, a fatty acid soap, and a polyalcohol. Those surfactants may be used alone or in combination thereof. The content of the surfactant may also be appropriately set in accordance with the configuration desired of the honeycomb structure portion to be obtained. The content of the surfactant is preferably 0.1 mass % or more and 2 mass % or less with respect to 100 parts by mass of the total mass of the silicon carbide powder and the metal silicon powder.

Any appropriate material may be used as the pore former as long as the material disappears to form pores through firing. Examples of the pore former include graphite, starch, resin balloons, a water-absorbing resin, and silica gel. The content of the pore former may also be appropriately set in accordance with the configuration desired of the honeycomb structure portion to be obtained. The content of the pore former is preferably 0.5 mass % or more and 10 mass % or less with respect to 100 parts by mass of the total mass of the silicon carbide powder and the metal silicon powder. The average particle diameter of the pore former is preferably from 10 μm to 30 μm. When the average particle diameter of the pore former is excessively small, pores cannot be sufficiently formed in some cases. When the average particle diameter of the pore former is excessively large, the die is clogged with the forming raw material at the time of forming in some cases. The average particle diameter of the pore former may be measured by, for example, a laser diffraction method.

The content of the water may also be appropriately set in accordance with the configuration desired of the honeycomb structure portion to be obtained. The content of the water is preferably from 20 mass % to 60 mass % with respect to 100 parts by mass of the total mass of the silicon carbide powder and the metal silicon powder.

Next, the forming raw material is kneaded to form a kneaded material. Any appropriate device/mechanism may be adopted as kneading means. Specific examples thereof include a kneader and a vacuum clay kneader.

Next, the kneaded material is extruded to form a honeycomb formed body. In the extrusion, there may be used a die having a configuration corresponding to the desired overall shape, cell shape, partition wall thickness, cell density, and the like of the honeycomb structure portion. For example, a wear-resistant cemented carbide may be used as a material for the die. The partition wall thickness, cell density, outer peripheral wall thickness, and the like of the honeycomb formed body (i.e., the configuration of the die) may be appropriately set in accordance with the desired configuration of the honeycomb structure portion to be obtained in consideration of shrinkage in drying and firing to be described later.

Next, the honeycomb formed body is dried to provide a honeycomb dried body. Any appropriate method may be used as a method for the drying. Specific examples thereof include: an electromagnetic wave heating system, such as microwave heat-drying or dielectric heat-drying (e.g., high-frequency dielectric heat-drying); and an external heating system, such as hot air drying or superheated steam drying. In at least one embodiment of the present invention, two-step drying may be performed. The two-step drying includes drying out a certain amount of water by the electromagnetic wave heating system, and then drying out the remaining water by the external heating system. According to such two-step drying, the entire formed body can be rapidly and uniformly dried in such a manner as not to cause a crack. More specifically, the two-step drying includes removing 30 mass % to 99 mass % of water with respect to the water content of the honeycomb formed body before drying by the electromagnetic wave heating system, and then reducing the water content of the honeycomb dried body to 3 mass % or less by the external heating system. The electromagnetic wave heating system is preferably dielectric heat-drying, and the external heating system is preferably hot air drying.

Next, the honeycomb dried body is fired to provide the honeycomb structure portion. In at least one embodiment of the present invention, calcination may be performed before the firing. When the calcination is performed, the binder and the like can be satisfactorily removed. The calcination may be performed, for example, in the atmosphere at from 400° C. to 500° C. for from 0.5 hour to 20 hours. The firing may be performed, for example, in an inert atmosphere of nitrogen, argon, or the like at from 1,400° C. to 1,500° C. for from 1 hour to 20 hours. The calcination and the firing may be performed using any appropriate means. The calcination and the firing may be performed using, for example, an electric furnace or a gas furnace.

Finally, the pair of electrode portions is formed at predetermined positions on the honeycomb structure portion (e.g., as illustrated in FIG. 1, on the outer peripheral surface of the outer peripheral wall across the central axis of the honeycomb structure portion) to provide the honeycomb structure. The electrode portions are formed by applying an electrode portion-forming paste to predetermined positions on the honeycomb structure portion, and drying and firing the applied electrode portion-forming paste.

The electrode portion-forming paste contains: silicon carbide powder; metal silicon powder and/or metal silicide powder; and as required, a binder, a surfactant, a pore former, water, and the like. As described in the section A-3, the silicon carbide powder contains α-SiC and β-SiC at a predetermined ratio. Further, as described in the section A-3, the D50 of the silicon carbide is 25 μm or less, the D50 of α-SiC is preferably from 10 μm to 45 μm, and the D50 of β-SiC is preferably from 10 μm to 45 μm. A blending ratio between the silicon carbide powder and the metal silicon powder and/or the metal silicide powder may be adjusted in accordance with the contents of the silicon carbide and the binding material described in the section A-3.

The binder, the surfactant, the pore former, the water, and the like are as described above for the honeycomb structure portion-forming raw material. The drying and the firing are also as described above for the formation of the honeycomb structure portion.

At least one embodiment in which the electrode portions are formed on the honeycomb structure portion (i.e., after the firing of the honeycomb dried body) has been described above. However, the honeycomb structure portion and the electrode portions may be simultaneously formed by applying the electrode portion-forming paste to the honeycomb dried body (before the firing) and firing the resultant.

Thus, the honeycomb structure may be produced.

B. Electric Heating Support

The honeycomb structure according to at least one embodiment of the present invention can be suitably used for an electric heating support. Accordingly, an electric heating support using such honeycomb structure may also be encompassed in at least one embodiment of the present invention. An electric heating support according to at least one embodiment of the present invention includes the honeycomb structure 200 described in the section A, and metal terminals (not shown) arranged on the electrode portions 120 and 120 of the honeycomb structure 200. One of the metal terminals is connected to the positive pole of a power source (e.g., a battery), and the other metal terminal is connected to the negative pole of the power source (e.g., the battery). As required, a base layer may be formed between each of the electrode portions and the metal terminal thereon. The base layer serves as a base for laser welding or thermal spraying at the time of joining with the metal terminals, and hence preferably has a function as a stress-alleviating layer. That is, when a difference in linear expansion coefficient between the electrode portions and the metal terminals is large, there is a risk in that the electrode portions may be cracked owing to a thermal stress. In view of this, the base layer preferably has a function of alleviating the thermal stress caused by the difference in linear expansion coefficient between the electrode portions and the metal terminals. With this configuration, the cracking of the electrode portions at the time of joining of the metal terminals to the electrode portions and/or due to fatigue from repeated thermal cycles can be suppressed. The base layer may be formed by thermal spraying, or may be formed by firing a base layer-forming paste.

The metal terminals may be a pair of metal terminals arranged so that one of the metal terminals is opposed to the other metal terminal across the central axis of the honeycomb structure. When a voltage is applied via the electrode portions, the metal terminals can be energized to cause, with Joule heat, the honeycomb structure to generate heat. Accordingly, the electric heating support can also be suitably used as a heater. The voltage to be applied may be appropriately set in accordance with purposes. The voltage to be applied may be, for example, from 12 V to 900 V, or may be, for example, from 48 V to 600 V.

Any appropriate metal may be used as a material for each of the metal terminals. For example, an elemental metal may be used, or an alloy or the like may be used. From the viewpoints of corrosion resistance, electrical resistivity, and the linear expansion coefficient, for example, an alloy containing at least one kind selected from Cr, Fe, Co, Ni, and Ti is preferred, and stainless steel and an Fe—Ni alloy are more preferred.

A material for the base layer is not particularly limited. For example, a composite material (cermet) of a metal and ceramics (especially conductive ceramics) may be used as the material for the base layer. However, the material is preferably capable of alleviating the thermal expansion difference between the electrode portions and the metal terminals.

The configuration of the base layer is not particularly limited. The base layer preferably contains, for example, one kind or two or more kinds of metals selected from a Ni-based alloy, an Fe-based alloy, a Ti-based alloy, a Co-based alloy, metal silicon, and Cr. The base layer is more preferably formed of a Ni-based alloy, an Fe-based alloy, a Ti-based alloy, or a Co-based alloy. Examples of the Ni-based alloy include inconel and hastelloy. Examples of the Fe-based alloy include stainless steels, such as SUS430. An example of the Ti-based alloy is a JIS 60 type (ASTM B348 Gr5). An example of the Co-based alloy is stellite. This is because of heat resistance at from 600° C. to 800° C. Of those, an Fe-based alloy (e.g., ferrite-based stainless steel) is preferred for the reason that its thermal expansion difference from the honeycomb structure is small, enabling a reduction in thermal stress.

In at least one embodiment of the present invention, the base layer may contain one kind or two or more kinds of ceramics selected from oxide-based ceramics, such as alumina, mullite, zirconia, glass, and cordierite; and non-oxide-based ceramics, such as silicon carbide, silicon nitride, and aluminum nitride. This is because of the following reasons: the thermal expansion coefficient is adjusted so that the stress due to the thermal expansion difference between the metal terminals and the electrode portions can be alleviated; and the oxidation of the metal contained in the base layer is suppressed.

In at least one embodiment of the present invention, the base layer is formed of a composite material containing stainless steel and glass. Examples of the glass include borosilicate glass, aluminosilicate glass, and soda lime glass. An example of the aluminosilicate glass is a Mg—Al—Si-based oxide (e.g.; MgO—Al₂O₃—SiO₂).

In the electric heating support, a catalyst may be typically supported by the partition walls 30 of the honeycomb structure 200. When the catalyst is supported by the partition walls, CO, NOₓ, a hydrocarbon, and the like in the exhaust gas can be converted into harmless substances through a catalytic reaction in the case where the exhaust gas is flowed through the cells 20. The catalyst may preferably contain a noble metal (e.g., platinum, rhodium, palladium, ruthenium, indium, silver, or gold), aluminum, nickel, zirconium, titanium, cerium, cobalt, manganese, zinc, copper, tin, iron, niobium, magnesium, lanthanum, samarium, bismuth, barium, and a combination thereof. Any such element may be contained as an elemental metal, a metal oxide, or any other metal compound. The supported amount of the catalyst may be, for example, from 0.1 g/L to 400 g/L.

In the electric heating support, when a voltage is applied to the honeycomb structure 200, the honeycomb structure can be energized to generate heat with Joule heat. Thus, the catalyst supported by the honeycomb structure (substantially, the partition walls) can be heated to the activating temperature before starting the engine or at the time of starting the engine. As a result, the exhaust gas can be sufficiently treated (typically, purified) even at the time of starting the engine.

C. Exhaust Gas Treatment Device

The electric heating support according to at least one embodiment of the present invention can be suitably used for an exhaust gas treatment device. Accordingly, an exhaust gas treatment device using such electric heating support may also be encompassed in at least one embodiment of the present invention. An exhaust gas treatment device according to at least one embodiment of the present invention includes the electric heating support described in the section B, and a can member for holding the electric heating support. The can member is any appropriate tubular member (for example, made of a metal). The exhaust gas treatment device is typically installed in the middle of an exhaust gas flow path through which an exhaust gas from an engine of an automobile is to be flowed.

### EXAMPLES

Now, the present invention is specifically described by way of Examples. However, the present invention is not limited by these Examples. Evaluation items in Examples are as described below. In addition, “part(s)” and “%” in Examples are by mass unless otherwise specified.

(1) Volume Resistivity

The volume resistivity of an electrode portion was measured at 25° C. by a four-terminal method. Specifically, a measurement sample for volume resistivity measurement was produced by being cut out of an electrode portion of a honeycomb structure. The entire surfaces of both end portions of the produced measurement sample were coated with a silver paste, and provided with a wiring line to enable energization. A voltage applying current measuring device was connected to the measurement sample to apply a voltage. A voltage of from 10 V to 200 V was applied, and a current value and a voltage value under a 25° C. state were measured. The volume resistivity (Ω·cm) was calculated from the resultant current value and voltage value, and the dimensions of the measurement sample. When the value of the volume resistivity falls within the range of from 0.07 Ω·cm to 1.2 Ω·cm, the electrode portion is suitably adjusted to have resistance in a low-resistance region.

(2) Porosity

The porosity of an electrode portion was measured with a mercury porosimeter.

(3) Particle Size

The particle sizes of silicon carbide were measured by the following method. An electrode portion was cut out of a honeycomb structure, and was subjected to acid treatment to dissolve its components other than the silicon carbide. Then, only the silicon carbide was taken, and washed and dried, followed by the measurement of its particle sizes by a laser diffraction method.

(4) Continuity with Thermally Sprayed Base Layer

Continuity with a thermally sprayed base layer was evaluated as follows. The heat generation distribution of the thermally sprayed base layer and an electrode portion at a time when the electrode portion was energized with a power of from 1.0 kW to 2.0 kW was determined. The heat generation distribution was determined by thermography, and visually judged by the following evaluation criteria.

⊚ (Excellent): There is no local heat generation at the boundary between the electrode layer and the thermally sprayed base layer.

∘ (Satisfactory): There is slight local heat generation at the boundary between the electrode layer and the thermally sprayed base layer.

x (Unsatisfactory): There is remarkable local heat generation at the boundary between the electrode layer and the thermally sprayed base layer.

### Example 1

A kneaded material containing metal silicon powder and silicon carbide powder was extruded and then dried to provide a honeycomb dried body that was to finally have such a shape as illustrated in FIG. 1. Next, a pair of electrode portions was formed at positions opposed to each other across the central axis of the resultant honeycomb dried body. A specific procedure was as follows. 30 Parts of metal silicon powder, 35 parts of α-type silicon carbide powder, 35 parts of β-type silicon carbide powder, 0.5 part of methyl cellulose, 10 parts of glycerin, and 38 parts of water were mixed in a planetary centrifugal mixer to prepare an electrode portion-forming paste. The resultant electrode portion-forming paste was applied to the above-mentioned electrode portion forming positions. The honeycomb dried body having applied thereto the electrode portion-forming paste was degreased and fired to provide a honeycomb structure. The degreasing was performed in the atmosphere at 450° C. for 5 hours. The firing was performed in an argon atmosphere at 1,450° C. for 2 hours. In this case, the D10, D50, and D90 of each of α-type silicon carbide powder and β-type silicon carbide powder were as shown in Table 1. The resultant honeycomb structure had a diameter of 75 mm, a length of 33 mm in a direction in which cells extended, a cell density of 57 cells/cm², and a partition wall thickness of 0.3 mm. Each of the formed electrode portions had a thickness of 230 μm, and a central angle in a section in a direction orthogonal to the flow path direction of the honeycomb structure portion (angle defined by lines connecting the central axis to both ends of each of the electrode portions) of 45°. The electrode portions had a volume resistivity of 0.40 Ω·cm, and a porosity of 32.5%. Further, the D10, D50, and D90 of the silicon carbide in the electrode portions were as shown in Table 1.

(Formation of Thermally Sprayed Base Layer)

Metal (SUS430) powder, glass (MgO—Al₂O₃—SiO₂) powder, methyl cellulose, glycerin, and water were mixed in a planetary centrifugal mixer to prepare a base layer-forming paste. In this case, the metal powder and the glass powder were blended at the following volume ratio: metal powder:glass powder=40:60. In addition, with respect to 100 parts by mass in total of the metal powder and the glass powder, 0.5 part by mass of methyl cellulose, 10 parts by mass of glycerin, and 38 parts by mass of water were blended. The average particle diameter of the metal powder was 10 μm. The average particle diameter of the glass powder was 5 μm. Then, the base layer-forming paste was applied so as to partly cover the electrode portions formed in the foregoing to provide a honeycomb structure with the base layer-forming paste. Then, the honeycomb structure with the base layer-forming paste was dried at 80° C. for 1 hour with hot air, and then subjected to firing treatment under the conditions of being put in an argon atmosphere at 1,000° C. for 2 hours to form a thermally sprayed base layer. Thus, a honeycomb structure of this Example was obtained. The resultant honeycomb structure was subjected to the evaluation (4). The result is shown in Table 1.

### Examples 2 to 16 and Comparative Examples 1 to 7

Honeycomb structures were obtained in the same manner as in Example 1 except that the blending ratio among the metal silicon powder, the α-type silicon carbide powder, and the β-type silicon carbide powder in the electrode portion-forming paste, and their D10, D50, and D90 were changed as shown in Table 1. The volume resistivity and porosity of the electrode portions, and the D10, D50, and D90 of the silicon carbide in the electrode portions were as shown in Table 1. The resultant honeycomb structures were subjected to the same evaluation as in Example 1. The results are shown in Table 1.

TABLE 1

| | Blending ratio | | | | | | | | | | | | | | | | |
|---|---|---|---|---|---|---|---|---|---|---|---|---|---|---|---|---|---|
| | Electrode layer | | | SiC | | | | | | | | | | | | | Conti- |
| | | α- | β- | α- | β- | | | | | | | | | | | | nuity |
| | | type | type | type | type | Particle size of raw | | | | | | | | | | | with |
| | | sili- | sili- | sili- | sili- | material used (volume) | | | | | | Electrode portions | | | | | ther- |
| | Metal | con | con | con | con | α-type | | | β-type | | | Volume | | α + β-type | | | mally |
| | sili- | car- | car- | car- | car- | silicon carbide | | | silicon carbide | | | resis- | Poros- | silicon carbide | | | sprayed |
| | con | bide | bide | bide | bide | D10 | D50 | D90 | D10 | D50 | D90 | tivity | ity | D10 | D50 | D90 | base |
| | % | % | % | % | % | μm | μm | μm | μm | μm | μm | Ω · cm | % | μm | μm | μm | layer |
| Example 1 | 30.0 | 35.0 | 35.0 | 50 | 50 | 5.0 | 10.0 | 16.0 | 12.2 | 22.1 | 40.6 | 0.40 | 32.5 | 6.7 | 14.2 | 32.9 | ⊚ |
| Example 2 | 30.0 | 49.0 | 21.0 | 70 | 30 | 5.0 | 10.0 | 16.0 | 12.2 | 22.1 | 40.6 | 0.71 | 34.9 | 5.9 | 11.8 | 27.1 | ⊚ |
| Example 3 | 30.0 | 3.5 | 66.5 | 5 | 95 | 11.0 | 15.4 | 21.4 | 12.2 | 22.1 | 40.6 | 0.08 | 22.2 | 12.1 | 21.5 | 39.9 | ◯ |
| Example 4 | 30.0 | 7.0 | 63.0 | 10 | 90 | 11.0 | 15.4 | 21.4 | 12.2 | 22.1 | 40.6 | 0.09 | 22.6 | 11.9 | 21.0 | 39.2 | ◯ |
| Example 5 | 30.0 | 21.0 | 49.0 | 30 | 70 | 11.0 | 15.4 | 21.4 | 12.2 | 22.1 | 40.6 | 0.24 | 34.4 | 11.6 | 19.1 | 36.7 | ⊚ |
| Example 6 | 30.0 | 35.0 | 35.0 | 50 | 50 | 11.0 | 15.4 | 21.4 | 12.2 | 22.1 | 40.6 | 0.29 | 23.0 | 11.4 | 17.6 | 32.9 | ⊚ |
| Example 7 | 30.0 | 49.0 | 21.0 | 70 | 30 | 11.0 | 15.4 | 21.4 | 12.2 | 22.1 | 40.6 | 0.48 | 23.9 | 11.2 | 16.5 | 27.6 | ⊚ |
| Example 8 | 30.0 | 63.0 | 7.0 | 90 | 10 | 11.0 | 15.4 | 21.4 | 12.2 | 22.1 | 40.6 | 0.98 | 32.1 | 11.1 | 15.7 | 22.6 | ⊚ |
| Example 9 | 30.0 | 66.5 | 3.5 | 95 | 5 | 11.0 | 15.4 | 21.4 | 12.2 | 22.1 | 40.6 | 1.08 | 32.3 | 11.0 | 15.5 | 22.0 | ⊚ |
| Example 10 | 30.0 | 3.5 | 66.5 | 5 | 95 | 19.2 | 30.6 | 51.0 | 12.2 | 22.1 | 40.6 | 0.07 | 19.3 | 12.3 | 22.5 | 41.4 | ◯ |
| Example 11 | 30.0 | 7.0 | 63.0 | 10 | 90 | 19.2 | 30.6 | 51.0 | 12.2 | 22.1 | 40.6 | 0.08 | 19.3 | 12.5 | 22.9 | 42.1 | ◯ |
| Example 12 | 30.0 | 21.0 | 49.0 | 30 | 70 | 19.2 | 30.6 | 51.0 | 12.2 | 22.1 | 40.6 | 0.15 | 22.0 | 13.3 | 24.8 | 44.3 | ◯ |
| Example 13 | 30.0 | 14.0 | 56.0 | 20.0 | 80.0 | 24.2 | 43.7 | 75.9 | 12.2 | 22.1 | 40.6 | 0.11 | 20.9 | 12.9 | 24.8 | 51.5 | ◯ |
| Example 14 | 30.0 | 35.0 | 35.0 | 50.0 | 50.0 | 11.0 | 15.4 | 21.4 | 20.1 | 33.4 | 57.8 | 0.28 | 22.9 | 12.2 | 20.9 | 47.2 | ◯ |
| Example 15 | 30.0 | 35.0 | 35.0 | 50.0 | 50.0 | 11.0 | 15.4 | 21.4 | 11.7 | 19.4 | 33.6 | 0.30 | 24.1 | 11.2 | 16.9 | 27.8 | ⊚ |
| Example 16 | 30.0 | 35.0 | 35.0 | 50.0 | 50.0 | 11.0 | 15.4 | 21.4 | 6.8 | 11.3 | 19.5 | 0.41 | 33.2 | 8.0 | 13.6 | 20.8 | ⊚ |
| Compar- | 30.0 | 0.0 | 70.0 | 0 | 100 | — | — | — | 12.2 | 22.1 | 40.6 | 0.06 | 19.7 | 12.2 | 22.1 | 40.6 | ◯ |
| ative | | | | | | | | | | | | | | | | | |
| Example 1 | | | | | | | | | | | | | | | | | |
| Compar- | 30.0 | 70.0 | 0.0 | 100 | 0 | 11.0 | 15.4 | 21.4 | — | — | — | 1.34 | 31.5 | 11.0 | 15.4 | 21.4 | ⊚ |
| ative | | | | | | | | | | | | | | | | | |
| Example 2 | | | | | | | | | | | | | | | | | |
| Compar- | 30.0 | 35.0 | 35.0 | 50 | 50 | 24.2 | 43.7 | 75.9 | 12.2 | 22.1 | 40.6 | 0.21 | 17.3 | 14.7 | 31.3 | 64.0 | X |
| ative | | | | | | | | | | | | | | | | | |
| Example 3 | | | | | | | | | | | | | | | | | |
| Compar- | 30.0 | 35.0 | 35.0 | 50 | 50 | 19.2 | 30.6 | 51.0 | 12.2 | 22.1 | 40.6 | 0.25 | 20.3 | 14.3 | 26.6 | 46.7 | X |
| ative | | | | | | | | | | | | | | | | | |
| Example 4 | | | | | | | | | | | | | | | | | |
| Compar- | 30.0 | 49.0 | 21.0 | 70 | 30 | 19.2 | 30.6 | 51.0 | 12.2 | 22.1 | 40.6 | 0.38 | 18.8 | 15.9 | 28.3 | 48.7 | X |
| ative | | | | | | | | | | | | | | | | | |
| Example 5 | | | | | | | | | | | | | | | | | |
| Compar- | 30.0 | 63.0 | 7.0 | 90 | 10 | 19.2 | 30.6 | 51.0 | 12.2 | 22.1 | 40.6 | 0.52 | 17.0 | 18.0 | 29.8 | 50.3 | X |
| ative | | | | | | | | | | | | | | | | | |
| Example 6 | | | | | | | | | | | | | | | | | |
| Compar- | 30.0 | 66.5 | 3.5 | 95 | 5 | 19.2 | 30.6 | 51.0 | 12.2 | 22.1 | 40.6 | 0.56 | 16.8 | 18.6 | 30.2 | 50.7 | X |
| ative | | | | | | | | | | | | | | | | | |
| Example 7 | | | | | | | | | | | | | | | | | |

As is apparent from Table 1, in the honeycomb structures of Examples of the present invention, the electrode portions are each adjusted to have resistance in a low-resistance region, and are each also excellent in continuity with the thermally sprayed base layer.

The honeycomb structure according to at least one embodiment of the present invention and the electric heating support using the same can be suitably used for the treatment (purification) of an exhaust gas from an automobile.

According to at least one embodiment of the present invention, the honeycomb structure including electrode portions each capable of having its resistance adjusted in a low-resistance region can be achieved.

Many other modifications will be apparent to and be readily practiced by those skilled in the art without departing from the scope and spirit of the invention. It should therefore be understood that the scope of the appended claims is not intended to be limited by the details of the description but should rather be broadly construed.

What is claimed is:

1. A honeycomb structure, comprising:
a honeycomb structure portion having:
an outer peripheral wall; and
a partition wall arranged inside the outer peripheral wall to define a plurality of cells each extending from a first end surface of the honeycomb structure portion to a second end surface thereof to form a flow path; and
a pair of electrode portions arranged on an outer peripheral surface of the outer peripheral wall of the honeycomb structure portion,
wherein the electrode portions are each a porous body in which particles of silicon carbide are bound by a binding material,
wherein the silicon carbide contains α-type silicon carbide and β-type silicon carbide, and
wherein the silicon carbide has a D50 in a volume-based cumulative particle size distribution of 25 μm or less.

2. The honeycomb structure according to claim 1,
wherein the α-type silicon carbide has a D50 of from 10 μm to 45 μm, and
wherein the β-type silicon carbide has a D50 of from 10 μm to 45 μm.

3. The honeycomb structure according to claim 1, wherein a content of the α-type silicon carbide in the silicon carbide is from 5 mass % to 95 mass %.

4. The honeycomb structure according to claim 1, wherein the electrode portions each have a volume resistivity of from 0.01 Ω·cm to 2.0 Ω·cm.

5. The honeycomb structure according to claim 1, wherein the binding material contains metal silicon, a metal silicide, or a combination thereof.

6. An electric heating support, comprising:
the honeycomb structure of claim 1; and
a pair of metal terminals arranged on the pair of electrode portions of the honeycomb structure, respectively.

7. The electric heating support according to claim 6, further comprising a base layer arranged between each of the electrode portions of the honeycomb structure and the metal terminal thereon.

8. An exhaust gas treatment device, comprising:
the electric heating support of claim 6; and
a can member configured to hold the electric heating support.

9. A honeycomb structure, comprising:
a honeycomb structure portion having:
an outer peripheral wall; and
a partition wall arranged inside the outer peripheral wall to define a plurality of cells each extending from a first end surface of the honeycomb structure portion to a second end surface thereof to form a flow path; and
a pair of electrode portions arranged on an outer peripheral surface of the outer peripheral wall of the honeycomb structure portion,
wherein the electrode portions are each a porous body in which particles of silicon carbide are bound by a binding material,
wherein the silicon carbide contains α-type silicon carbide and β-type silicon carbide, and a content of the α-type silicon carbide in the silicon carbide is from 5 mass % to 95 mass %,
wherein the binding material contains metal silicon, a metal silicide, or a combination thereof,
wherein the silicon carbide has a D50 in a volume-based cumulative particle size distribution of 25 μm or less, the α-type silicon carbide has a D50 of from 10 μm to 45 μm, and the β-type silicon carbide has a D50 of from 10 μm to 45 μm, and
wherein the electrode portions each have a volume resistivity of from 0.01 Ω·cm to 2.0 Ω·cm.

10. An electric heating support, comprising:
the honeycomb structure of claim 9;
a pair of metal terminals arranged on the pair of electrode portions of the honeycomb structure, respectively; and
a base layer arranged between each of the electrode portions of the honeycomb structure and the metal terminal thereon.

11. An exhaust gas treatment device, comprising:
the electric heating support of claim 10; and
a can member configured to hold the electric heating support.
